(19) United States
(12) Patent Application Publication
(10) Pub. No.: US 2004/0010542 A1
(43) Pub. Date: Jan. 15, 2004

(54) Managed service apparatus, systems, and methods

(75) Inventors: Arvind Kumar, Beaverton, OR (US); Murali Sundar, Portland, OR (US); Alok Prakash, Beaverton, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/194,626

(22) Filed: Jul. 11, 2002

(51) Int. Cl. G06F 15/16

(52) U.S. Cl. 709/203

(57) ABSTRACT

A service management apparatus may include a services object manager (SOM), along with a portal server, a poller-scheduler, a domain information provider, and a memory, each communicatively coupleable to the SOM in one embodiment A service management system may include a service management apparatus communicatively coupleable to a domain data source. A method of managing a service may include activities such as discovering the service, receiving a subscription for the service, creating a subscribed service including customer-specific parameters associated with a subscribing customer and service-specific parameters associated with the service, activating the subscribed service, and publishing information associated with the subscribed service. In another embodiment, an article comprising a machine-accessible medium controls these activities.

### TECHNICAL FIELD

Embodiments of the present invention relate generally to apparatus, systems, and methods used for data processing and computer user interface management. More particularly, embodiments of the present invention relate to providing multiple users of a service with individual, customized access to the service, presenting the appearance of a managed single-user interface to each user.

### BACKGROUND INFORMATION

Traditional data center operations tools, such as backup, security, and network monitoring, are typically implemented on an infrastructure-centric basis. Such tools have been devised, often at great expense, to provide one or more services within a particular operational entity. Thus, there is no concept associated with these services of a “customer” as such, but merely the use of one or more services available within the entity, such as a data processing center.

With increased access to information by small to medium-sized businesses via the Internet and other networks, a marketing niche has arisen: the provision of computational and information management services to businesses unable to afford custom application development, either with respect to time, or money. While some service providers have come to the market with newly-developed, multi-customer enabled software to provide such services, there are many others that wish to offer these services using legacy tools, developed in-house for a single entity, on a multi-customer basis. Such tools have a history of operating on a daily basis in a real-world environment, providing the additional benefit of proven performance.

In selling services to consumers, the ability to offer a product which is competitively priced, free from operational inconsistency, and readily available on a semi-custom basis is important. However, attempting to deploy legacy tools in the form of newly-developed, customized versions for individual customers is expensive, time-consuming, and fraught with many of the problems inherent in any programming development effort.

In addition, some legacy tools, while operating at a suitable level within a particular entity, may not be capable of meeting consumer expectations which have come to be common for any basic service offering, such as the generic ability to accommodate the usage preferences of multiple customers (and users which make up a single customer), gather usage statistics, provide customer-specific control, health, and status reports, and operational problem alerting (typically associated with customer-specific recovery procedures).

Another difficulty in converting such tools for use by a variety of customers is creating a customer-centric operational view, such that the application interface is consistent across multiple customers, and possibly, across multiple service offerings. Each tool may have distinct interface requirements. Further, while many businesses share operational and logistical characteristics, so as to be somewhat the same, there are also unique needs which must be addressed, such as requirements for operational problem alerting, service billing, and reporting.

Therefore, there is a need in the art for an apparatus, an article including a machine-accessible medium, a system, and a method for rapidly converting legacy tools into service offerings. Such services should be suitable for use over networks, such as the Internet, and should include the accommodation of multiple-customers, customer-specific usage preferences, customer-specific alerting and reporting, and billing. Solving this need would enable the conversion of in-house, single-user tools into multi-user services in a cost-effective manner, providing an additional revenue stream to the service provider.

### BRIEF DESCRIPTION OF THE DRAWINGS

FIG. 1 is a functional block diagram of a data center offering managed services according to an embodiment of the present invention;

FIG. 2 is a functional block diagram of a multiple association engine, including an apparatus, article, and system according to various embodiments of the present invention;

FIG. 3 is a logical block diagram of an exemplary set of schema objects which may be instantiated by a Services Object Manager according to an embodiment of the present invention; and

FIG. 4 is a flow diagram of a method for managing a service according to an embodiment of the present invention.

### DESCRIPTION OF EMBODIMENTS OF THE INVENTION

In the following detailed description of various embodiments of the invention, reference is made to the accompanying drawings which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. The following detailed description, therefore, is not to be taken in a limiting sense, and the scope of various embodiments of the invention is defined only by the appended claims, along with the full range of equivalents to which such claims are entitled.

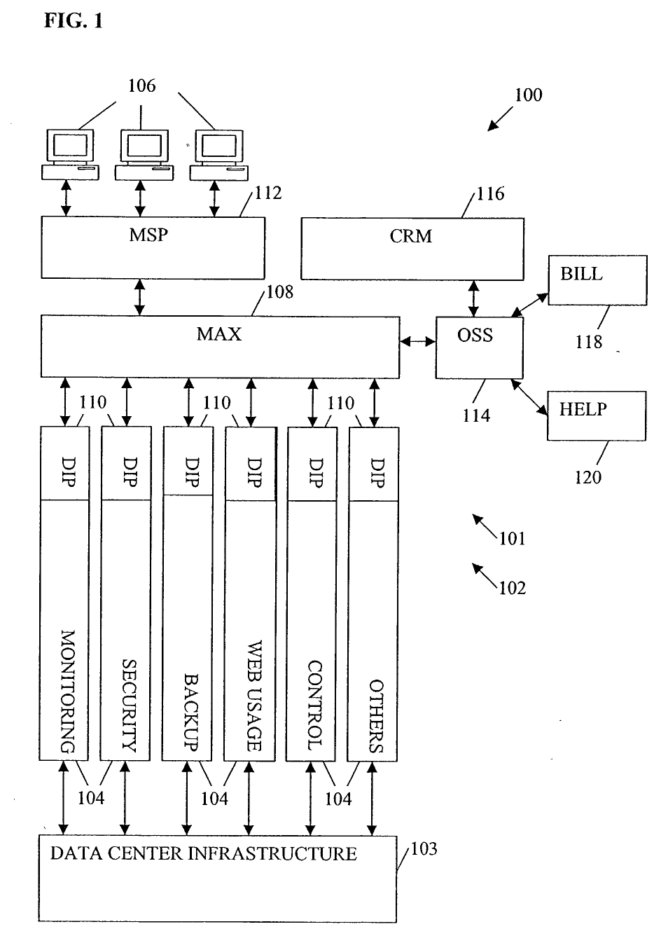

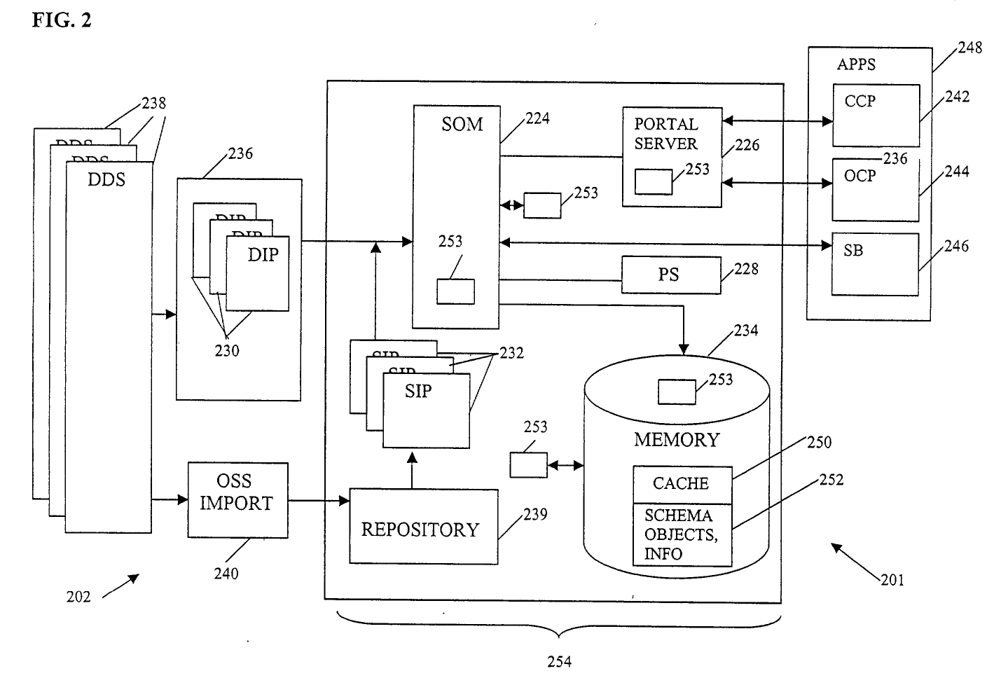

FIG. 1 is a functional block diagram of a data center offering managed services according to an embodiment of the present invention. FIG. 1 provides an overview of how the apparatus 101 and system 102 fit into the overall operation of the data center 100 according to various embodiments of the invention. The data center infrastructure module 103 represents a collection of the existing data center operations tools as they are typically deployed in data centers. The infrastructure 103 thus includes systems, applications, networking equipment, system and network management software, backup solutions, security infrastructure, etc. The infrastructure 103 also include various services 104, such as monitoring, security, backup, web usage, control, problem resolution, and others, which a service provider might wish to provide to its customers via suitable user interfaces, such as terminals 106. The Multiple Association (MAX) engine 108, described in greater detail with respect to FIG. 2, below, manages the multiple-customer interface between the services 104 and the terminals 106, via Domain Information Providers (DIPs) 110, a Managed Services Portal (MSP) 112, and one or more Operations Support System (OSS) 114 applications interfaces. The MSP 112 operates to expose services to a particular customer or its agent. Alternatively, directly-served customers may include Hosting Service Providers (HSPs), Management Service Providers (MSPs), Internet Service Providers (ISPs), and Application Service Providers (ASPs) operating as “channel partners” in order to provide each of their own customers with a full-service solution, albeit indirectly. In any event, the MAX module 108, the MSP module 112, and the OSS module 114 operate together to provide features expected by the consuming public with respect to customized data center service offerings, such as Customer Resource Management (CRM) 116, billing 118 and help desk 120 access. Of course, such features are merely examples of the many business support systems that a service provider might require to conduct operations.

For example, backing up software and data has come to be an essential part of prudent computer operational procedures, especially in the business context. Such activity may be provided by an HSP, which has a data center and an operations center offering web-site hosting services, as another service. In this case, customers could go to the HSP web-site, view the available services for each server the customer operates, and request provision of the backup service. Various embodiments of the invention enable the HSP to purchase an off-the-shelf backup application, partition the features of the application, and expose them as individual services to which the customer can subscribe. Such applications are not typically offered as a service to multiple users, but are designed for one large company to manage its needs. Thus, some embodiments of the invention may enable the provision of partitioned file and server mapping, monitoring backup operations, service billing, status reporting, and (scheduled) automatic initiation of the service. In this manner, an enterprise backup tool can be delivered as a tailored service package to many customers.

FIG. 2 is a functional block diagram of a multiple association engine, including an apparatus, article, and system according to various embodiments of the present invention. In one embodiment, the service management apparatus 201 may include a Services Object Manager (SOM) 224, a Portal Server 226, a Poller-Scheduler (PS) 228, one or more Domain Information Providers (DIPs) 230, one or more static Domain Information Providers (SIPs) 232, and a memory 234, each capable of being communicatively coupled to the SOM 224. For reference purposes, it should be noted that the MAX 108 engine of FIG. 1 may include the SOM 224, the memory 234, and one or more DIPs 230 operating in an execution environment 236, which acts as a host for the DIPs 230.

The SOM 224 is a module which tracks the operations of other modules, and their relationships. Each module may be represented by an object in the SOM 224. For the purposes of this document, an “object” may be defined as a logical entity that represents the modules constituting a service to a customer. Examples of some of the base objects include, but are not limited to, customers, services, reports, alerts, alert response procedures, and service level agreements. Such objects can be further specified and divided into different classes or types. For example, a service may be a backup service, a system monitoring service, an application monitoring service, a remote control service, and so forth. Association objects may be used to represent the relationships among various collections of objects.

The data model, behavior, and relationships between objects may be defined using human and computer-readable “schema”. Thus, the schema may constitute the definition of the object model, while objects themselves may be the instantiation of the schema constructs.

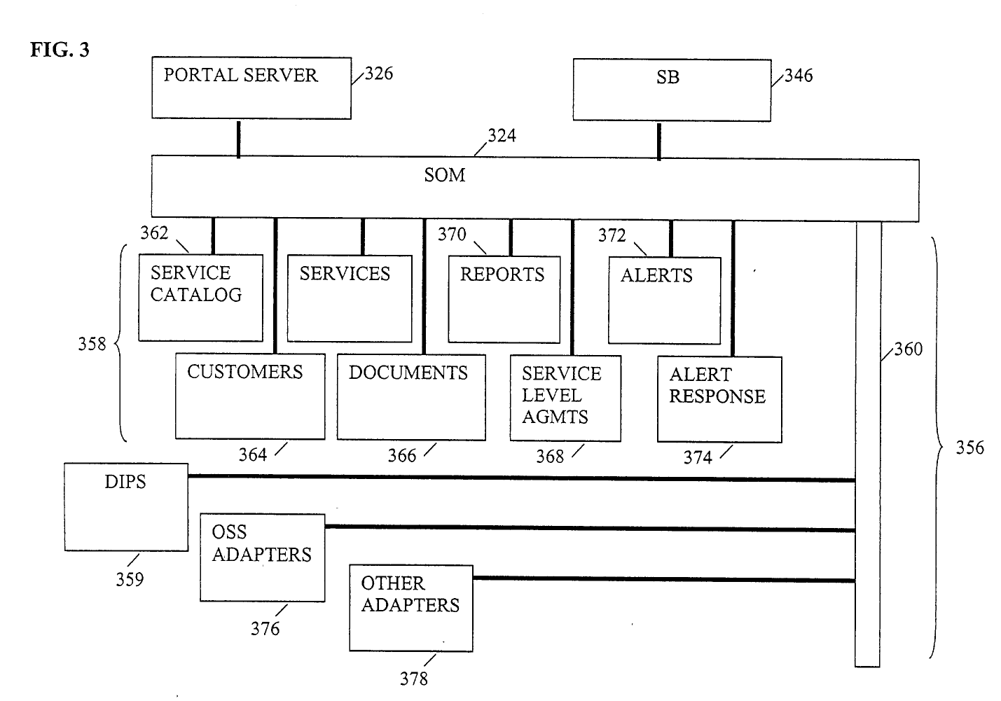

Items which may be tracked by the SOM 224 include customer identity and customer-specific information, service catalogs, subscribed services, service parameters, customer-service resource mapping, alert response procedures, service level agreements, customer documents, etc. All of this information is represented using one or more schema (shown in more detail by example in FIG. 3 below), which can be instantiated into live objects. Thus, the SOM 224 maintains the relationship between the instantiated objects, and it allows the DIPs 230 and SIPs 232 to create the live objects. Once instantiated, the SOM 224 can expose the live objects to other modules.

Typically, many thousands of operations are monitored within the apparatus 201. While some events are published, many are not, and some way to sample the state of the apparatus 201 periodically is usually necessary. Thus, the PS 228 may be used to set up periodic status sampling within the apparatus 201, including maintenance of an event polling schedule and distribution of selected activities over various time intervals.

Domain Information Providers may be dynamic, as represented by DIPs 230, or static, as represented by SIPs 232. DIPs 230 interface with one or more Domain Data Sources (DDSs) 238 using native interfaces, such as a programmatic applications interface (e.g., a Microsoft® Windows®-compatible Applications Program Interfaces (APIs), .NET (Microsoft® .NET Framework, Version SP1, 2002) APIs, COM (Component Object Model Specification, Version 0.9, 1995) APIs, Windows® Performance Monitor APIs, WMI (Windows® Management Instrumentation, Version 1.5, 2000) APIs, MOM (Microsoft® Operations Manager, Version 1.0, 2001) APIs, Windows®/Unix Device Driver APIs, etc.), a remote procedure call, a message bus, a web services interface (e.g., XML (Extensible Markup Language 1.0, October 2000), SOAP (Simple Object Access Protocol, Version 1.2, December 2001), and various Java web services), system management protocols (e.g. SNMP (Simple Network Management Protocol, Version 3, 2001), CIM (Common Information Model, Version 2.2, 1999), DMI (Desktop Management Interface, Version 2.0, 1996), etc.), sockets, or gathering data from databases, directories, and files. DIPs 230 make queries in real time to provide the most up-to-date data available from the DDSs 238, as needed. Thus, a dynamic Domain Information Provider, referred to as a DIP 230, can be communicatively coupled to a DDS 238.

SIPs 232 do not interface directly with a business or operational system. Rather, SIPs 232 read and update information to be supplied to the SOM 224 using a repository 239, such as a file system, directory, database, etc. Thus, a static Domain Information Provider, referred to as a SIP 232, can be communicatively coupled to a repository 239.

DDSs 238 may be business and/or operational support systems in the data centers (included in the infrastructure 103 of FIG. 1), including the services to be provided to each customer on an individualized basis. Thus, DDSs 238 may include a Help Desk, Trouble Ticket Management, Billing, CRM systems, device monitoring products, system backup utilities, etc. The OSS Import module 240 is capable of being coupled to the DDSs 238, to the DIPs 230, and to the SIPs 232, and thus may accept data from the DDSs 238 and send it on to the repository 239 for use by the SIPs 232.

As noted previously, the Portal Server 226 is capable of being communicatively coupled to a Customer Control Panel (CCP) 242 and an Operations Control Panel (OCP) 244. The CCP 242 and OCP 244 allow customers and service providers, respectively, to view and control the activities of the apparatus 201. The Service Builder (SB) 246 is an application which gathers information from all the services (i.e., service-specific information), via the SOM 224, and allows the service provider to create service catalogs. The service catalogs are then published or exposed to the customers using the Portal Server 226, which also provides the features of customer authentication, login, secure access, as well as customization of each service offered. The CCP 242, OCP 244, as well as the Service Builder (SB) 246 are all applications 248 or modules which can manipulate objects exposed by the SOM 224.

The memory 234 may be coupled to the SOM 224, and may include a cache 250 for storing various items. Examples of items 252 which may be cached in the memory 234 include Schema, DIP and SIP Information, and Static Objects.

Also shown in FIG. 2 is the service management system 202 according to an embodiment of the invention, which may include a service management apparatus 201 (having an SOM 224, a Portal Server 226, one or more DIPs 230, and one or more SIPs 232), and one or more DDSs 238 capable of being communicatively coupled to the apparatus 201. Within the system 202, the apparatus 201 may also include a PS 228 and a memory 234, each capable of being communicatively coupled to the SOM 224.

It should be noted that the apparatus 201, the system 202, the SOM 224, the Portal Server 226, the PS 228, the DIPs 230, the SIPs 232, the memory 234, the DDSs 238, the repository 239, the repository 239, the OSS import module 240, the CCP 242, the OCP 244, the SB 246, the cache 250, and the stored items within cache 250 may all be characterized as “modules” herein. Such modules may include, or communicate with, hardware circuitry, such as a one or more processors and/or memory circuits, software program instructions, firmware, and/or combinations thereof (collectively 253), as directed by the architect of the apparatus 201 and system 202, and as appropriate for particular implementations of various embodiments of the invention.

One of ordinary skill in the art will understand that the service management apparatus and systems described herein can be used in applications other than desktop computers and systems which include networked servers or devices, and thus, various embodiments of the invention are not to be so limited. The illustrations of a service management apparatus 201 and a service management system 202 are intended to provide a general understanding of the structure of various embodiments of the present invention, and are not intended to serve as a complete description of all the elements and features of service management apparatus and systems which might make use of the structures described herein.

Applications which may include the novel service management apparatus and systems described herein include electronic circuitry used in high-speed computers, communications and signal processing circuitry, processor modules, embedded processors, and application-specific modules, including multilayer, multi-chip modules. Such service management apparatus and systems may further be included as sub-components within a wide variety of electronic systems, such as televisions, cellular telephones, personal computers, radios, vehicles, and others.

FIG. 3 is a logical block diagram of an exemplary set of schema objects 356 which may be instantiated by a Services Object Manager 324 (SOM) according to an embodiment of the present invention. The schema objects 356 can also be instantiated for manipulation by other modules to which the SOM 324 exposes them, e.g., the CCP and OCP (previously shown in FIG. 2) via the Portal Server 326, and the SB 346.

Schema for various Services 358 can be used to describe and/or model individual services offered to customers. Such Service schema 358 may also include customer-specific parameters. DIPs 359, typically coupled to an application integration bus 360, expose the functionality of data center operations tools (e.g., monitoring or backup applications) as one or more services, via the SOM 324, the Portal Server 326, and the SB 346. The Service Catalog schema 362 may include combinations of services (i.e., service packages) offered by the service provider to its customers.

Customer schema 364 are instantiations of individual customer accounts, wherein customers are typically subscribed to one or more services as represented via associations between the customer and “subscribed” service objects (which are instantiations of the appropriate services objects). For example, a customer desiring to subscribe to backup services for systems x, y, and z on a weekly basis might generate three instances of the “weekly backup service” subscribed service object. Additional “customer context” objects (not shown) may also be associated with Customer schema 364, which allow some embodiments of the invention to retain customer-specific information.

Document schema 366 are used to track objects shared between the service provider and the individual customer. Service Level Agreement schema 368 are instantiations of specific types of Document schema 366.

Report and Alert schema, 370, 372 respectively, provide dynamic health information about the services provided to individual customers, including operational status and problem alerts. Customers may also define procedures to be followed in response to certain events in the Alert schema 372. The Alert Response Procedure schema 374 are associated with the appropriate Alert schema 372 and procedural information provided by the customer.

OSS adapters 376, as well as other adapters 378, may also be coupled to the application integration bus 360. Of course, as noted above, the representation of the set of schema objects 356 is by no means complete, but is merely one example of an unlimited number which can be used.

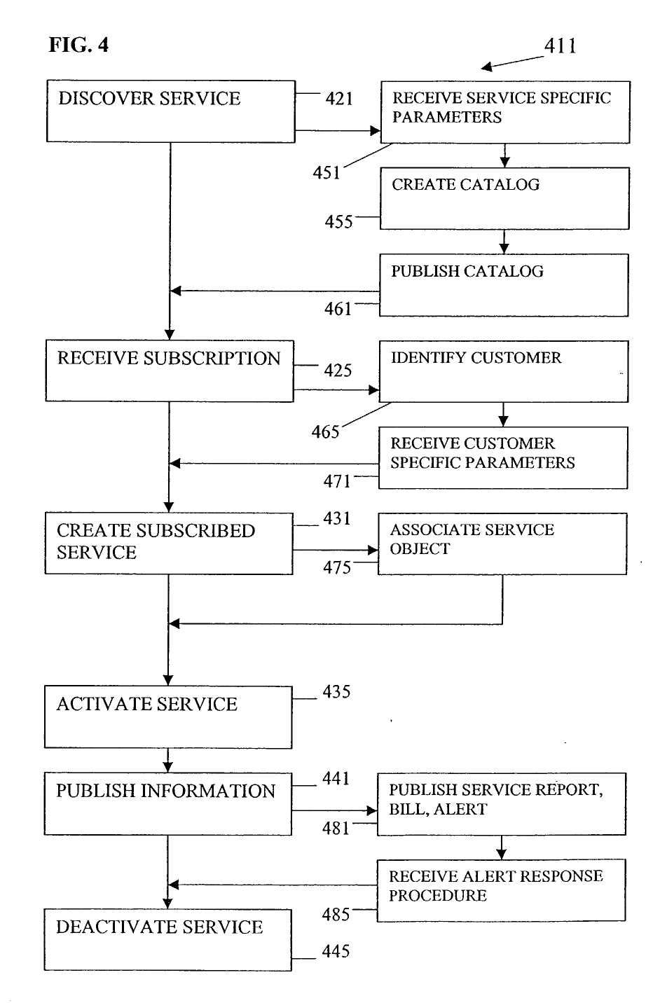

FIG. 4 is a flow diagram for a method of managing a service according to an embodiment of the present invention. Services are discovered through DIPs (see element 110 in FIG. 1 and element(s) 230 in FIG. 2), which are adapted to couple specific data center operational tools to the MAX (see element 108 in FIG. 1). Still referring to FIG. 4, each DIP interfaces with the functions of a particular tool or service, and exposes the features/capabilities of the tool/service as a common service object. The SOM (see element 224 in FIG. 2) then collects information from all the DIPs and exposes them to the other modules. Thus, the method 411 may include discovering the service at block 421, receiving a subscription from a customer for the service at block 425, creating a subscribed service at block 431 (which may have customer-specific parameters associated with the customer and service-specific parameters associated with the subscribed service), and activating the subscribed service at block 435. A subscribed service, or subscribed service object, thus represents the association of the customer and a service to which the customer subscribes. Based on this information, the service provisioner (which can be a manual or automated process) provisions and activates the subscribed services. Thereafter, the various subscribed services become operational, and can be updated to reflect their new status.

The method 411 may also include publishing information associated with the subscribed service at block 441. Thereafter, the method may include deactivating the service at block 445, if the customer decides to unsubscribe to the service. In an actual service management system, unsubscribed service objects are typically not deleted, but they are merely marked as deleted and held for auditing purposes until formal system purging occurs, usually after a predetermined time limit.

Service discovery at block 421 may include receiving the service-specific parameters associated with the service from a DIP at block 451, creating a catalog of services including the discovered service(s) at block 455, and publishing the service catalog at block 461.

Receiving a customer subscription at block 425 may include identifying the customer at block 465 and receiving customer-specific parameters at block 471. Thus, the customer may log in to the PS (see element 228 in FIG. 2) and view the list of available services via one or more service catalogs. The customer may then request particular services be provided, which signals the SOM (see element 224 in FIG. 2) to create additional subscribed services objects, which are in turn associated with the appropriate customer object. Therefore, creating a subscribed service may include associating a subscribed service object with a customer object, customer-specific parameters, and/or various service-specific parameters at block 475.

Publishing information associated with the subscribed service at block 441 may include publishing service reports, service alerts, and/or service bills at block 481. Each DIP may provide service report objects with data to produce actual reports on the status of a subscribed service interfaced to the DIP. The SOM may enumerate all of the report objects and aggregate the information for display to the customer via the PS.

DIPs, tailored to specific services, may also be used to create Alerts objects, which respond so as to alert (via visual, aural, or other means) customers whenever a desired set of circumstances arises with respect to a subscribed service. The OCP (see element 236 in FIG. 2) and CCP (see element 242 in FIG. 2) may then be used to view and act upon alerts as they occur. Thus, the method 411 may also include receiving an alert response procedure associated with the service alert at block 485, which allows the service provider to deal with the alert whenever it occurs.

For example, an alert response procedure may be considered analogous to a step-by-step cookbook directing a response when a particular service outage condition is detected. Building on the backup service example given previously, if the backup of a particular system fails, a monitoring system might alert the service provider (e.g., a data center operator), and the operator might follow various actions listed in the alert response procedure. Such actions might include: rebooting the server, and telephoning the customer to let him know that an outage or service failure has occurred.

Since any or all of the service objects may expose usage information, service bills may be published. Typically, a billing module compiles usage information from all of the subscribed service objects (for a specific customer) and generates a bill. The bill may then be presented to the customer via one or more reports objects, similar to other service report information.

It should be noted that while schema and objects have been used as exemplary representational mechanisms herein, other representational mechanisms may also be used according to the apparatus, systems, and methods disclosed herein, and therefore, various embodiments of the invention are not to be so limited. Therefore, it should be clear that some embodiments of the present invention may also be described in the context of computer-executable instructions, such as program modules, being executed by a computer. Generally, program modules may include routines, programs, objects, components, data structures, etc. that perform particular tasks or implement particular abstract data types. As such, and with reference again to FIG. 2, the memory 234 and/or any of the modules 224, 226, 228, 230, 232, 238, 239, 240, 242, 244, 246, 250, and 252 described herein may include software operative on one or more processors to perform methods according to the teachings of various embodiments of the present invention.

One of ordinary skill in the art will understand, upon reading and comprehending this disclosure, the manner in which a software program can be launched from a computer readable medium in a computer based system to execute the functions defined in the software program. One of ordinary skill in the art will further understand the various programming languages which may be employed to create one or more software programs designed to implement and perform the methods disclosed herein. The programs can be structured in an object-orientated format using an object-oriented language such as Java, Smalltalk, or C++. Alternatively, the programs can be structured in a procedure-orientated format using a procedural language, such as COBOL or C. The software components may communicate using any of a number of mechanisms that are well-known to those skilled in the art, such as application program interfaces (API) or interprocess communication techniques such as the remote procedure call. However, as will be appreciated by one of ordinary skill in the art upon reading this disclosure, the teachings of various embodiments of the present invention are not limited to any particular programming language or environment, including Hypertext Markup Language (HTML) and Extensible Markup Language (XML).

As is evident from the preceding description, and still referring to FIG. 2, it can be seen that a processor 253 typically accesses at least some form of computer-readable media, such as the memory 234. However, computer-readable and/or accessible media may be any available media that can be accessed by the apparatus 201 and system 202. By way of example and not limitation, computer-readable media may compromise computer storage media and communications media. Computer storage media includes volatile and non-volatile, removable and non-removable media implemented in any method or technology for storage of information such as computer-readable instructions, data structures, program modules or other data. Communication media specifically embodies computer-readable instructions, data structures, program modules or other data in a modulated data signal such as a carrier wave, coded information signal, and/or other transport mechanism, which includes any information delivery media. The term “modulated data signal” means a signal that has one or more of its characteristics set or changed in such a manner as to encode information in the signal. By way of example and not limitation, communications media also includes wired media such as a wired network or direct-wired connections, and wireless media such as acoustic, optical, radio frequency, infrared and other wireless media. Combinations of any of the above are also be included within the scope of computer-readable and/or accessible media.

Thus, it is now easily understood that another embodiment of the invention may include an article 254 comprising a machine-accessible medium having associated data, wherein the data, when accessed, results in a machine (e.g. a processor or computer) performing activities such as discovering a service offered through, or made available through a portal server (typically coupled to a SOM), receiving a subscription from a customer for the service, creating a subscribed service including customer-specific parameters associated with the customer and service-specific parameters associated with the service, activating the subscribed service, and publishing information associated with the subscribed service. Other activities may include, for example, creating a service catalog including the service and publishing the service catalog, as well as publishing one or more service reports and service bills. Of course, such activities may also include deactivating the subscribed service.

Although specific embodiments have been illustrated and described herein, those of ordinary skill in the art will appreciate that any arrangement which is calculated to achieve the same purpose may be substituted for the specific embodiments shown. This disclosure is intended to cover any and all adaptations or variations of various embodiments of the present invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of Embodiments of the Invention, with each claim standing on its own as a separate preferred embodiment.

What is claimed is:

1. An apparatus, comprising:
a services object manager (SOM);
a portal server capable of being communicatively coupled to the SOM; and
a domain information provider capable of being communicatively coupled to the SOM.

2. The apparatus of claim 1, wherein the portal server is capable of being communicatively coupled to a customer control panel and an operations control panel.

3. The apparatus of claim 1, wherein the domain information provider is a static information provider capable of being communicatively coupled to a repository.

4. The apparatus of claim 1, wherein the domain information provider is a dynamic information provider capable of being communicatively coupled to a domain data source.

5. The apparatus of claim 4, wherein the dynamic information provider is coupled to the domain data source using an interface selected from a programmatic applications interface, a remote procedure call, a message bus, a socket, or a web services interface.

6. The apparatus of claim 1, further comprising:
a poller-scheduler capable of being communicatively coupled to the SOM.

7. The apparatus of claim 1, further comprising:
a memory capable of being communicatively coupled to the SOM, wherein the memory includes a cache.

8. A system, comprising:
a service management apparatus including a services object manager (SOM), a portal server and a domain information provider; the portal server and domain information provider each capable of being communicatively coupled to the SOM; and
a domain data source capable of being communicatively coupled to the service management apparatus.

9. The system of claim 8, wherein the service management apparatus includes a poller-scheduler capable of being communicatively coupled to the SOM.

10. The system of claim 8, wherein the service management apparatus includes a memory capable of being communicatively coupled to the SOM.

11. The system of claim 8, wherein the memory is to store a schema.

12. The system of claim 8, further comprising:
an operations support system import module capable of being coupled to the domain data source and the domain information provider.

13. A method, comprising:
discovering a service offered through a portal server;
receiving a subscription for the service;
creating a subscribed service including customer-specific parameters associated with a customer and service-specific parameters associated with the service;
activating the subscribed service; and
publishing information associated with the subscribed service.

14. The method of claim 13, wherein discovering the service further comprises:
receiving the service-specific parameters associated with the service from a domain information provider.

15. The method of claim 13, wherein receiving a subscription for the service further comprises:
identifying the customer; and
receiving the customer-specific parameters.

16. The method of claim 13, wherein creating a subscribed service further comprises:
associating a subscribed service object with a customer object, the customer-specific parameters, and the service-specific parameters.

17. The method of claim 13, wherein publishing information associated with the subscribed service further comprises:
publishing a service alert.

18. The method of claim 17, further comprising:
receiving an alert response procedure associated with the service alert.

19. An article comprising a machine-accessible medium having associated data, wherein the data, when accessed, results in a machine performing:
discovering a service;
receiving a subscription for the service;
creating a subscribed service including customer-specific parameters associated with a customer and service-specific parameters associated with the service;
activating the subscribed service; and
publishing information associated with the subscribed service.

20. The article of claim 19, wherein the machine-accessible medium further includes data which, when accessed by the machine, results in the machine performing:
creating a service catalog including the service.

21. The article of claim 20, wherein the machine-accessible medium further includes data which, when accessed by the machine, results in the machine performing:
publishing the service catalog.

22. The article of claim 19, wherein publishing information associated with the subscribed service further comprises:
publishing a service report.

23. The article of claim 19, wherein publishing information associated with the subscribed service further comprises:
publishing a service bill.

24. The article of claim 19, wherein the machine-accessible medium further includes data which, when accessed by the machine, results in the machine performing:
deactivating the subscribed service.
